(19) United States
(12) Patent Application Publication
(10) Pub. No.: US 2009/0180421 A1
(43) Pub. Date: Jul. 16, 2009

(54) MULTIBAND MOBILE SATCOM TERMINAL

(76) Inventors: David Hall, McDonough, GA (US); Ronald Keith Gammon, Cumming, GA (US); Timothy P. Glennon, Rosewell, GA (US); Erwin Noble, Roswell, GA (US); Allen M. Webb, Lawrenceville, GA (US)

Correspondence Address: Brian Anderson, 5250 Meadowcreek Drive, Dunwoody, GA, 30338, US

(21) Appl. No.: 12/261,636

(22) Filed: Oct. 30, 2008

Related U.S. Application Data
(60) Provisional application No. 61/041,207, filed on Mar. 31, 2008.
(60) Provisional application No. 61/021,307, filed on Jan. 15, 2008.

(51) Int. Cl. H04B 7/185

(52) U.S. Cl. 370/316

(57) ABSTRACT

The multiband mobile SATCOM terminal is a small form factor, multi-band, multi-function, modular, vehicular-based tactical communications terminal that cross-bands radio and satellite systems for constant on the move communications.

### CROSS REFERENCE TO RELATED APPLICATION

This Application claims priority benefit under 35 U.S.C. 119(e) to U.S. Provisional Application Ser. No. 61/041,207 filed on Mar. 31, 2008, titled “Multi-Band Mobile Satellite Terminal,” and claims priority benefit under 35 U.S.C. 119(e) to U.S. Provisional Application Ser. No. 61/021,307 filed on Jan. 15, 2008, titled “Multi-Band Mobile Satellite Terminal,” both of which are hereby incorporated by reference in their entirety and made part hereof.

### FIELD OF THE PRESENT INVENTION

The present invention generally relates to mobile communication systems. More specifically, the present invention relates to cross-banding radio and satellite communications in a small form factor that is antenna and modem agnostic to support both on the move and on the halt communications.

### BACKGROUND OF THE PRESENT INVENTION

Communication is central to managing situations in a hostile environment, especially in context of a military operation or any emergency situation. A lack of communications and situational awareness paralyzes command and control. Accordingly, there is a need for real-time data that is driving the integration of radio and satellite technology into both commercial and military communication systems. To meet present demands, communication systems of the past are giving way to interoperable digital systems that will ensure constant communications.

Communication solutions in hostile environments require reliability, portability and ease of operation. Improvements in technology have enabled communication networks to be established literally anywhere around the world. Current hardware allows for the fast and efficient establishment of sophisticated telecommunications infrastructures.

On the military side, yesterday's model of using independent communication systems for different tactical functions simply does not fit with the network-centric warfare model being pursued by virtually every modem military. Today's forces are fast, mobile, tightly integrated and closely coordinated, which requires the ability to quickly and freely communicate across territorial boundaries as well as internal organizational boundaries. Advances in technology have meant that the establishment of constant communication while on the move in hostile environments can now be a cost-effective reality.

In order to meet the current communication needs, a communication network is needed that integrates the prevalent radio systems with satellite networks to manage constant real-time communications anywhere in the world. In order to adapt to differing operational situations, the system will need to provide on-the-move communications as well as heightened on-the-halt communications. For mass adoption, the system will need to occupy little or no additional space inside a vehicle. Finally, to ensure operational and tactical flexibility, the system will need to have multiple agnostic capabilities including antenna, modem and baseband functions.

### BRIEF DESCRIPTION OF THE DRAWINGS

Benefits and further features of the present invention will be apparent from a detailed description of preferred embodiments thereof taken in conjunction with the following drawings, wherein like reference numbers refer to like elements, and wherein:

FIG. 1 illustrates an exemplary overview of a cross-banded radio and satellite communication system.

FIG. 2 illustrates an exemplary embodiment of a perspective view of an installed multiband mobile SATCOM terminal.

FIGS. 3A and 3B illustrate exemplary embodiments of communication on the quick halt and communication on the move.

FIG. 4 illustrates an exemplary embodiment of a back and side view of a mounted multiband mobile SATCOM terminal.

FIGS. 5A AND 5B illustrate exemplary embodiments of a front and back perspective assembly views of the SATCOM unit.

FIG. 6 illustrates an exemplary embodiment of front and back perspective view of the mounted multiband mobile SATCOM terminal lower chassis.

FIG. 7 illustrates an exemplary embodiment of an internal view of the mounted multiband mobile SATCOM terminal lower chassis.

FIG. 8 illustrates an exemplary power distribution schematic.

FIG. 9 illustrates an exemplary embodiment of a software system.

FIG. 10 illustrates an exemplary architectural diagram of a network management suite.

FIG. 11 illustrates an exemplary interconnect diagram of the mounted multiband mobile SATCOM terminal system.

### DETAILED DESCRIPTION OF PREFERRED EMBODIMENTS

The multiband mobile SATCOM terminal (MMST) is a small form factor, multi-band, multi-function, modular, vehicular-based tactical satellite communications terminal. The MMST system provides a radio with line-of-site (LOS) UHF/VHF and over-the-horizon wideband satellite communications operating in any satellite frequency band including Ku, Ka, X, and C bands. Additionally, the MMST system has cross-banding capability enabling seamless line-of-site to over-the-horizon communications on the quick halt (COTH) and communications on-the-move (COTM). The system leverages modern reliable networks to extend communications beyond the physical limitation of customary land mobile radio RF propagation characteristics. The system is highly flexible by incorporating multiple agnostic capabilities including antenna, modem and baseband functions.

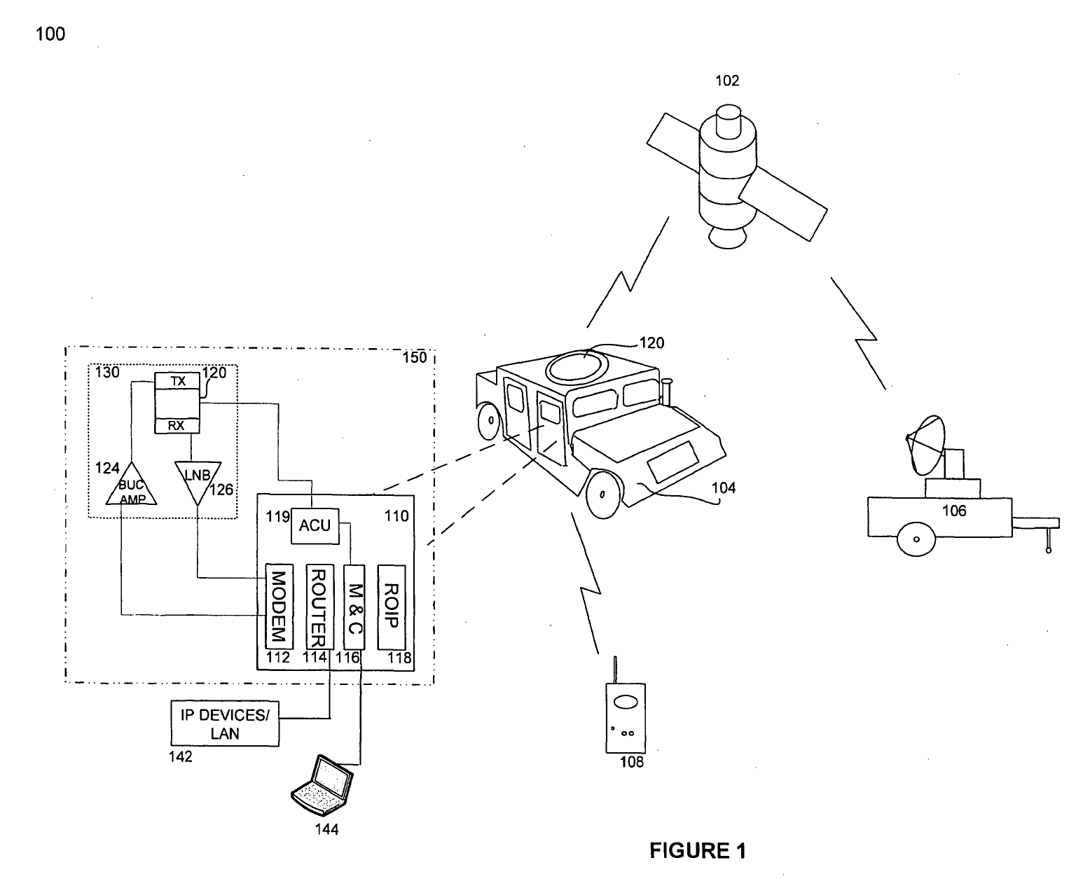

Turning to FIG. 1, illustrated is an overview of a cross-banded communication system 100 in which the present invention operates. The MMST system 150 is composed of two major subsystems; the MMST 110 and the RF subsystem 130. The RF subsystem 130 is primarily the satellite antenna 120 and associated components, and is typically located on the roof of the hosting vehicle 104. The MMST (IF subsystem) 110 contains the remainder of the equipment located entirely within the hosting vehicle 104. The interface between the two subsystems consists of a receive IF path, transmit IF path, and a control interface that is dependent upon the antenna 120. The IF interface between the two subsystems is L band. The conversion to, and from, the satellite frequency band is performed within the RF subsystem 130, typically with a low noise block converter 126 (LNB) on the receive side, and a block up converter (BUC) 124 on the transmit side.

Embodiments of the antenna subsystem 130 include a low noise block (LNB) 126 for converting the received block of higher microwave frequencies such as Ka, Ku, X or C RF and providing L-band to the IF subsystem 110. On the transmit side, the antenna subsystem 130 employs a block up converter (BUC) 124 for converting the L-band IF to Ka, Ku, X or C band. The antenna control unit (ACU) 119 is responsible for positioning the antenna to the desired satellite and maintaining the position during operation. The ACU 119 is controlled by the monitor and control unit (M&C) 116.

The IF subsystem 110 includes the satellite modem 112, where the baseband side is Ethernet and the IF side is L-band. The other components are the radio over IP (RoIP) unit 118, Internet Protocol (IP) router 114, and a monitor and control unit 116. M&C screens are operable to set configuration options for the modem 112, ACU 119, RoIP 118, and router 114. An external laptop 144 interfaces with the M&C unit 116 to provide a heightened graphical interface for the system 155.

The IP router 114 functions as the portal to the satellite traffic data via the modem 112 and external connectivity 142. Preferably, the ports support serial (RS-232), Ethernet, and USB devices. The MMST 110 interfaces baseband audio onto an IP network. The RoIP interface 118 enables audio and push to talk (PTT) connectivity between a remote satellite station 106 and an external audio communications radio 108.

MMST system 150 enables Joint tactical radio system (JTRS) Enhanced Multiband inter/intra team radio (MBITR) JEM/MBITR communications to be seamlessly cross-banded and retransmitted over a satellite communication link. The MMST 110 captures analog audio, used by land mobile radio systems 108 (radio, base station, dispatch console, etc), and converts that audio signal to digital datagram, which in turn, is transported over an IP network (further described in reference to FIG. 12) in the form of RoIP (Radio over Internet Protocol) data. The terminal 110 also addresses the essential control signals used by land mobile radio systems 108.

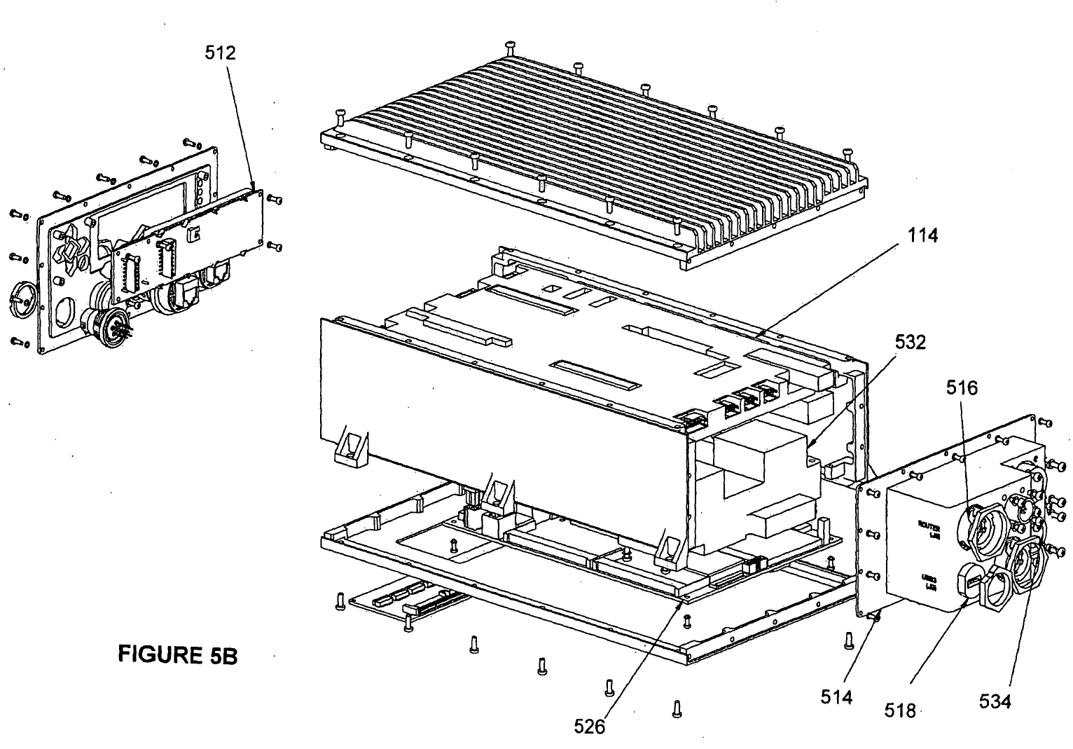

Conventional widely deployed land mobile radios (LMR) 108 communicate with a remote mobile unit 104 when the LMRs 108 are not in communication range of their base station. An integrated LMR is attached to the SATCOM system (described in reference to FIG. 5) and is dedicated to providing connectivity between the LMR network and the satellite network. This dedicated radio is a modified joint tactical radio system (JTRS) enhanced multiband inter/intra team radio (MBITR) such as provided by THALES COMMUNICATIONS, INC., and in turn, the integrated tactical radio is connected to the system 150 by way of back panel connections. Ethernet ports are supplied on the back panel to allow the use of a separate encryption device.

A local user (inside the vehicle) communicates voice traffic directly over the satellite link or the LMR link by using a headphone set attached to the laptop 114 or to the USB port on the front panel and using a voice communications software application. A laptop 144, video camera, Voice over IP phone or other IP equipment 142 provide data connectivity over the satellite link. Depending on the equipment type, either an Ethernet port or the USB port on the front panel may be used. The user simply plugs the equipment into the front panel. A laptop 144 with appropriate client software is used and connected via the Ethernet port if a graphical display is desired to operate the equipment.

Satellites 102 connect remote mobile units 104 with other satellite stations 106 located well beyond LOS communications. The MMST 110, installed within the remote mobile unit 104, enables seamless cross-banding satellite communication capability and provides a tactical satellite communication system 100 with a high data rate for mobile applications.

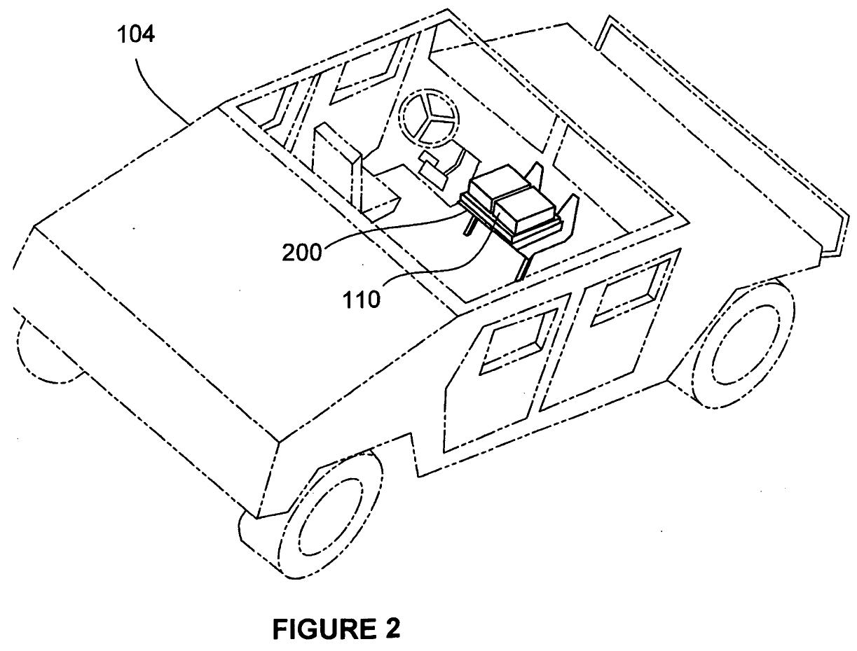

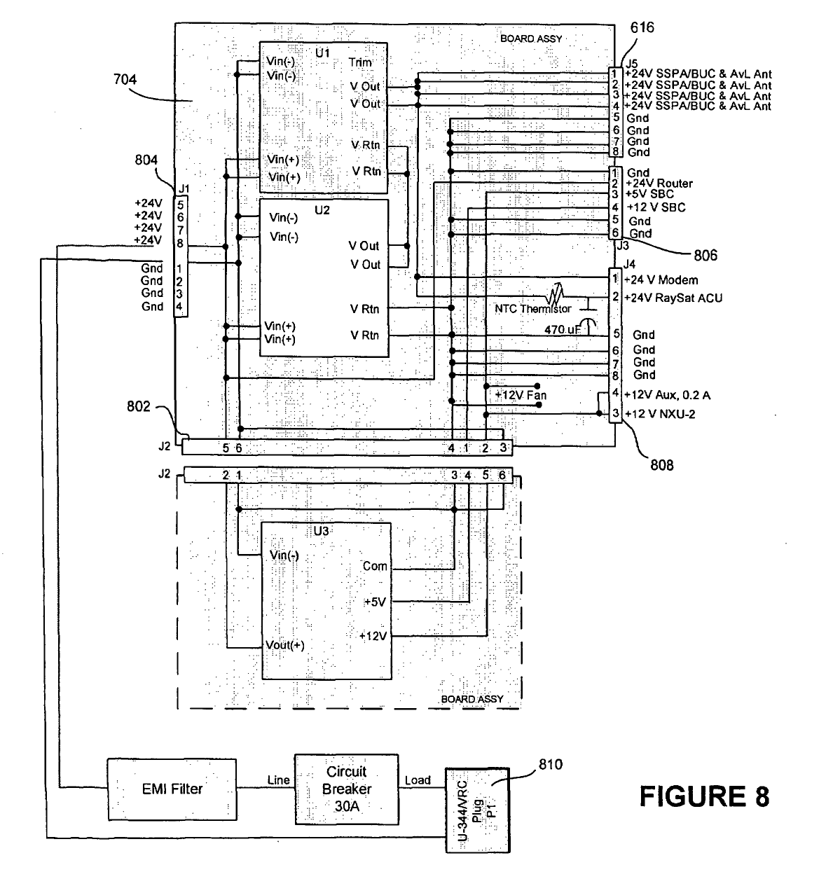

Turning now to FIG. 2, illustrated is a perspective view of a remote mobile unit 104 with an MMST 110 installed. As shown, the MMST 110 is a small form factor, multi-band, multi-function, rugged, vehicular-based tactical satellite communications terminal. The MMST 110 combines the following elements into a compact package: a modified tactical land mobile radio 108, Radio over IP adapter 118, satellite modem 112, IP router/switch 114, certified encryption for transmission security (transec), antenna control unit 119, DC/DC power supply (described further in reference to FIG. 8), single board computer (described further in reference to FIG. 5), and front panel keypad/display.

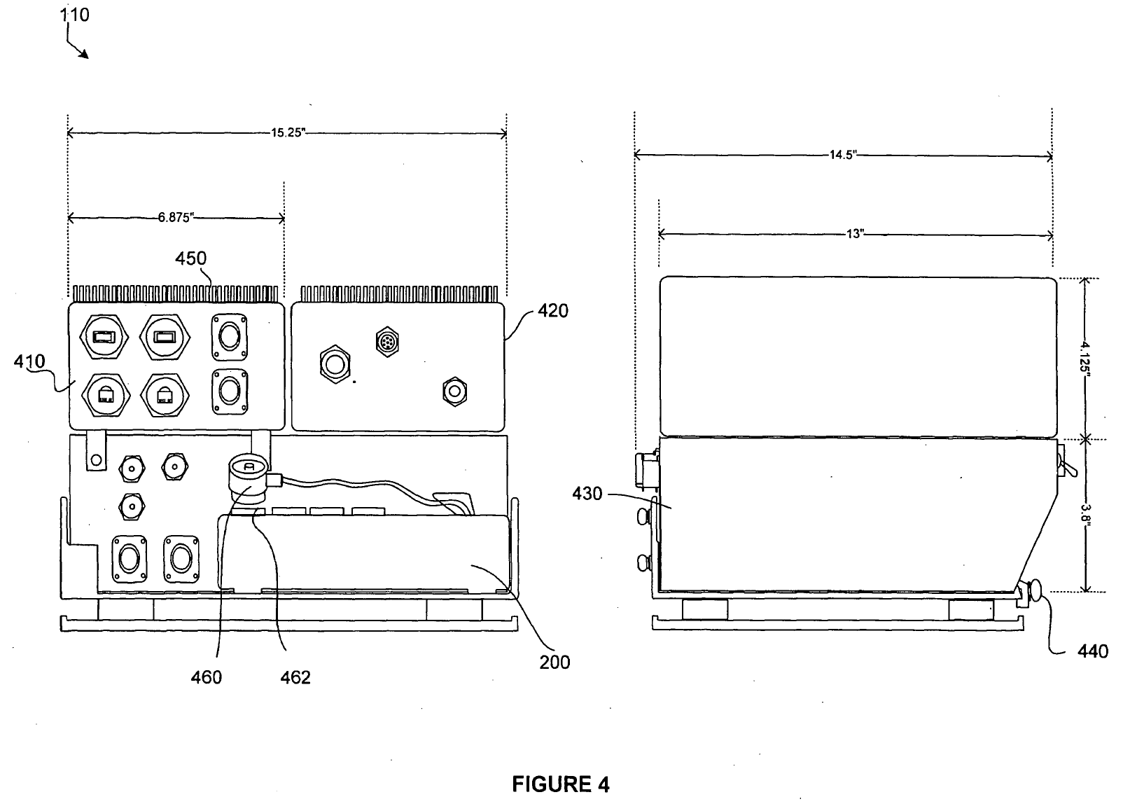

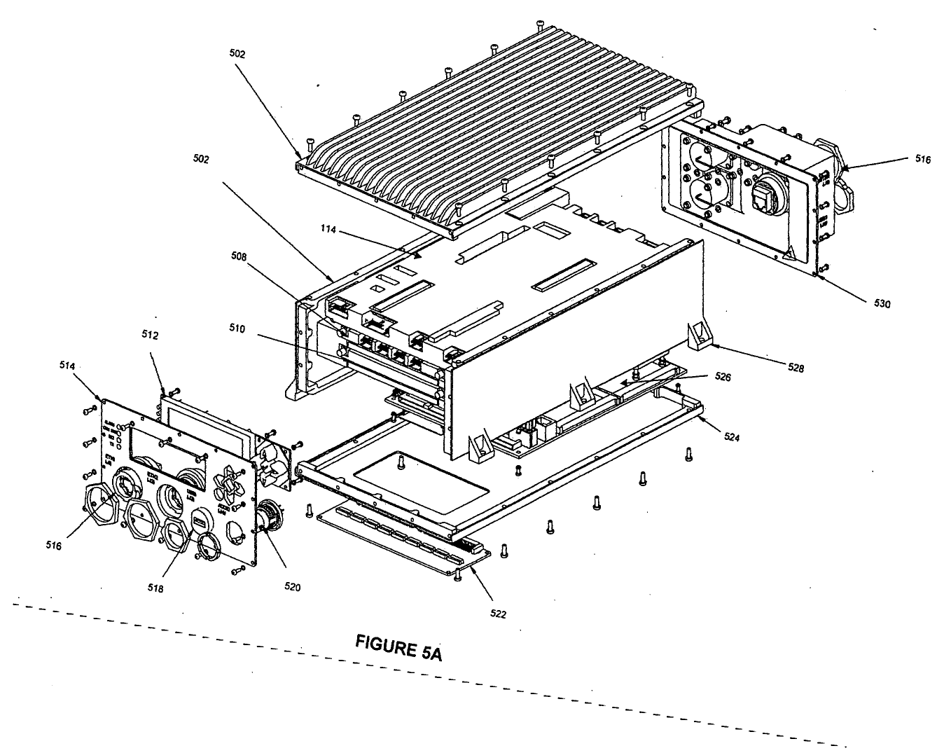

Within the vehicle 104, the MMST 110 consumes little or no additional space inside vehicle from that of a conventional military radio system. The MMST 110 is designed mechanically and electrically to interface directly to a standard Single Channel Ground and Airborne Radio System (SINCGARS) mounting tray 200 (shown in greater detail in FIG. 4) currently mass installed in DOD and NATO MOD vehicles 104. The system 150 gets its primary DC power through the blind mate connector 462 in the SINCGARS tray 200. System 150 makes use of the SINCGARS tray mechanical mounting and locking mechanism.

Size reduction is achieved by eliminating the housing and power supplies from each of the items and mechanically mounting the functional circuit cards from each of the units into a common chassis driven by a common power supply. Circuit cards for individual elements are attached to the chassis housing through a series of stacked plates and stand-offs to provide mechanical stability as needed to survive the vibration and shock of portable environment.

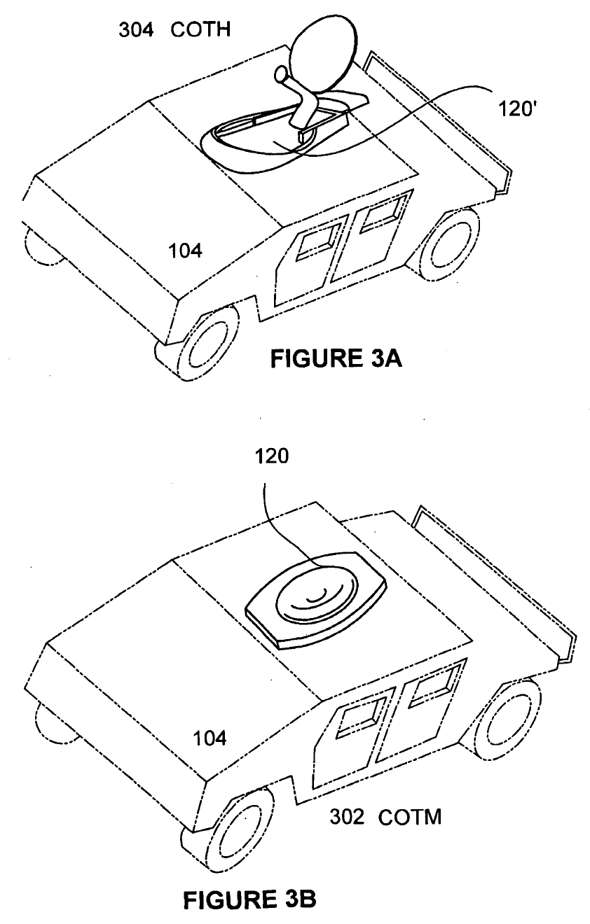

Turning now to FIGS. 3A and 3B, illustrated are perspective views of remote mobile units 104. The MMST system 150 is a rugged product for installation in a wide variety of vehicles 104. The MMST system 150 enables both multi-band satellite Communications on the Quick Halt (COTH) 304 with an extendable antenna 120′ as depicted in FIG. 3A and Communications on the Move (COTM) 302 with a flat antenna 120 as depicted in 3B. The MMST system 150 is antenna agnostic and band scalable.

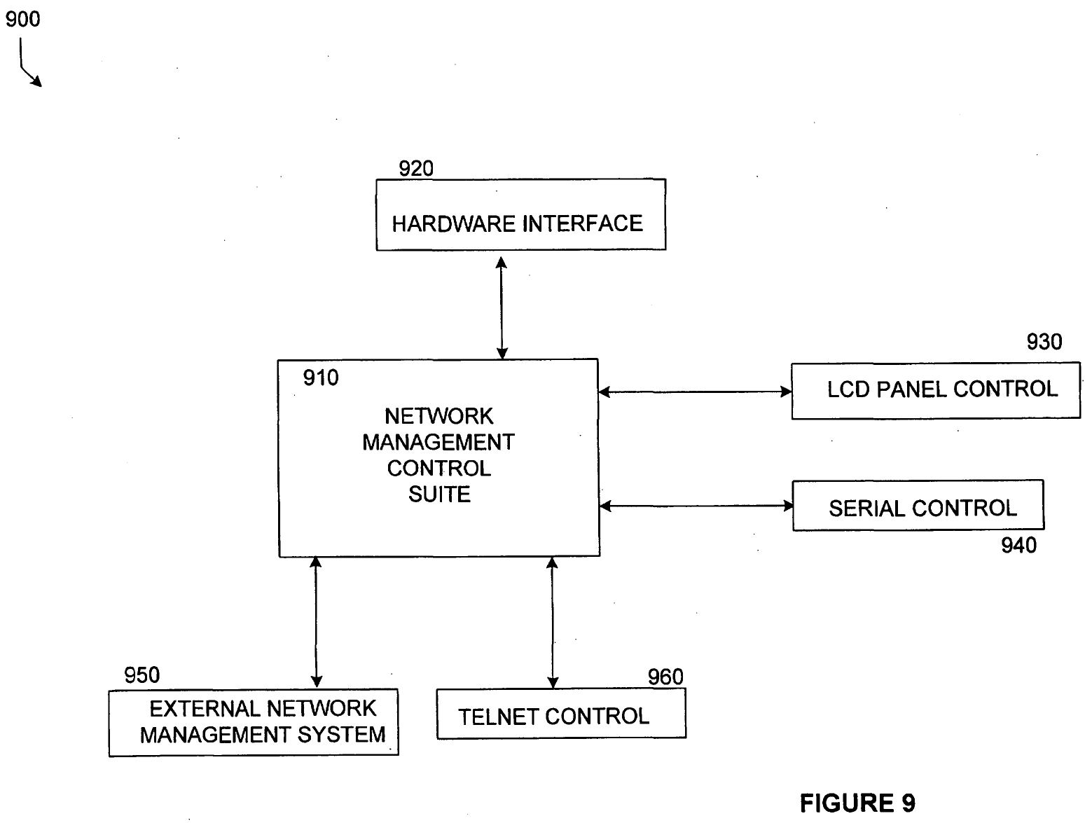

The system 150 uses several techniques that result in an antenna agnostic capability. This functionality allows both on-the-move 302 and on-the-halt antenna system 304 solutions to be provided. The system 150 uses a standard L-Band interface between the MMST chassis 110 and the antenna group 130. By using an integrated L-Band block upconverter 124 and LNB 126 as part of the antenna group 130, any antenna system 130 can readily be used. Antenna agnostic capability is also enabled by integrating a modular antenna controller unit 119, specific to the antenna 120, into the MMST chassis 110. Simply plugging in the antenna control unit 119 into the chassis 110 enables any antenna system 130 to be used. For those antenna systems 130 with the ACU 119 integrated into the antenna pedestal, the mobile link unit 110 includes both serial and Ethernet interfaces for control of the antenna system 130. The chassis 110 also includes an embedded network management control software and element management system as described further in reference to FIG. 9. The network management control system (NMCS) is highly configurable through installation of antenna specific driver software. This NMCS allows a common antenna control interface that can be used with any antenna system 130. The system also includes multiple DC power supplies that support a variety of antenna systems 130 that may require different DC voltages, e.g., 24V and 48V.

For example, the MMST 110 is operable to use a RAYSAT low-profile antenna 120 for COTM 304 operations and an AVL drive-away antenna 120′ for COTH 304 operations. The system 150 is installed without requiring modifications to the host vehicle 104 beyond that required to mount the antenna 120.

MMST system 150 utilizes vehicular mounted directional antenna 120 to support mission requirements that conduct SATCOM OTM communications 302 with satellites 20 degrees above the horizon or higher. The system 150 is capable of quick installation on tactical vehicles 104. This ease of installation enables the system 150 to be deployed on various vehicles 104 as any unique mission might dictate. The MMST system 150 is also designed to be a mission agnostic system. The system works in all types of terrain. The speed of the vehicle has negligible impact on data rates Up to normal driving speeds. Since the vehicle can communicate while on the move, its visibility will make it vulnerable. The antenna system 130 has a low profile to reduce the possibility of detection and thus reduce the threat of the vehicle being singled out for attack.

The satellite communications 100 on the quick halt 304 is similar to the SATCOM on the move system 302 with the exception of the antenna 120′. To support higher bandwidth and more efficient communication, the system 150 operates when the vehicle 104 is not moving. This lack of mobility places additional limitations on the mission, but enhances the communication efficiency and availability. A high gain, foldable, directional SATCOM band antenna 102′ is used in a static operation location. The SATCOM antenna 120′ includes the ability to conduct static SATCOM communications with satellites 10 degrees above the horizon or higher. The directional antenna can be erected away from the vehicle to facilitate positioning for LOS to the satellite and/or to mitigate co-site interference. While on the move the antenna 120′ is stowed to allow high speed movement and to reduce the visibility. Communications from outside the vehicle occurs while moving with hand held radios 108.

Preferably, antenna mounts use special tools to remove antenna 120 from vehicle 104 or requires the vehicle to be unlocked for removal. MMST system 150 allows for configuration differences resulting from inherit differences of the various missions by tactical vehicles 104. The data rates of the MMST for COTH 304 operations are orders of magnitude greater than the data rates of COTM 302 operations. Likewise, the data rates of COTM 302 operations are orders of magnitude greater than current UHF SATCOM products.

Turning now to FIG. 4, illustrated is a back and side view of a mounted MMST 110. The figure shows the primary mechanical structures of the MMST 110. The MMST 110 comprises a lower assembly 430 which house the removable modem 112 and ACU 119, as well as power distribution described in further detail in reference to FIG. 8. An upper assembly 410 provides user interaction and baseband equipment such as a single board computer and router functions. The MMST 110 is designed to fit into the cabin of the host vehicle 104 while the RF subsystem 130, including the antenna 120, is designed to fit on the roof of the vehicle 104 exposed to the elements.

The MMST 110 consists of a lower unit 430, an integrated tactical multiband UHF/VHF radio 420, and a SATCOM unit 410. The console 110 is contained within the same space envelope as consumed by current standard military vehicle radio system such as the THALES VRC-xxx, or HARRIS FALCON II or III. The total length of the MMST is approximately 14.5″, the width is approximately 15.25″, and the height is approximately 7.925″.

The MMST 110 is capable of operation in any tactical vehicle 104 that has an installed shock mount MT-6352 (SINCGARS mount tray) 200 without further mechanical modifications to the vehicle. The MMST lower unit 430 uses the SINCGARS mechanical mounting and locking mechanisms 440 to mount securely into the tray 200. The SATCOM unit 410 and the radio unit 420 mount securely on top of the lower unit 430. Each of these upper units is approximately 14.5″ in length, 6.875″ in width, and 4.125″ in height.

The MMST 110 includes tactical radio system 420 that supports communications to a network of mobile end users 108. The mobile end user device 108 can be a handheld unit or vehicle based radio unit. The integrated tactical radio 420 can communicate to other tactical radio users while mobile.

System 420 includes an integrated Radio over IP module 118 that converts the standard analog audio push-to-talk interface from the tactical radio to IP and supports bi-directional traffic. When interconnected via the IP network, the distant end system can use a software client or separate Radio over IP module 118 to present the PTT and audio to the user. PTT audio interface from the integrated tactical radio 420 unit is passed to the radio over IP module 118 to make it assessable to any end device connected to the IP network.

The MMST 110 includes a satellite modem 112 can be connected to a SATCOM-on-the move antenna system 130 allowing the terminal to communicate over the satellite link while moving. The satellite modem 112 passes IP traffic to the integral router 114 over an Ethernet interface.

The MMST 110 includes an integrated router 114 which is configured with VLAN tunnels to routers located in other fixed and mobile terminals to maintain communications while terminals are mobile. The integral router 114 interconnects the satellite network and the tactical radio network.

The integrated tactical radio 420 includes an asynchronous serial interface as a second communications interface available to the mobile users 108. The integrated single board computer includes client software that can convert the serial traffic to IP which is then passed over an Ethernet interface to the integrated router 114. The integrated satellite modem 112 includes an IP interface to the integrated router 114. Connection to the SATCOM on-the-move antenna system 302 enables mobile IP traffic, which is then passed to the SATCOM modem 112, allowing simultaneous mobile tactical radio users to communicate with the hub while simultaneously passing video and data over the same IP network

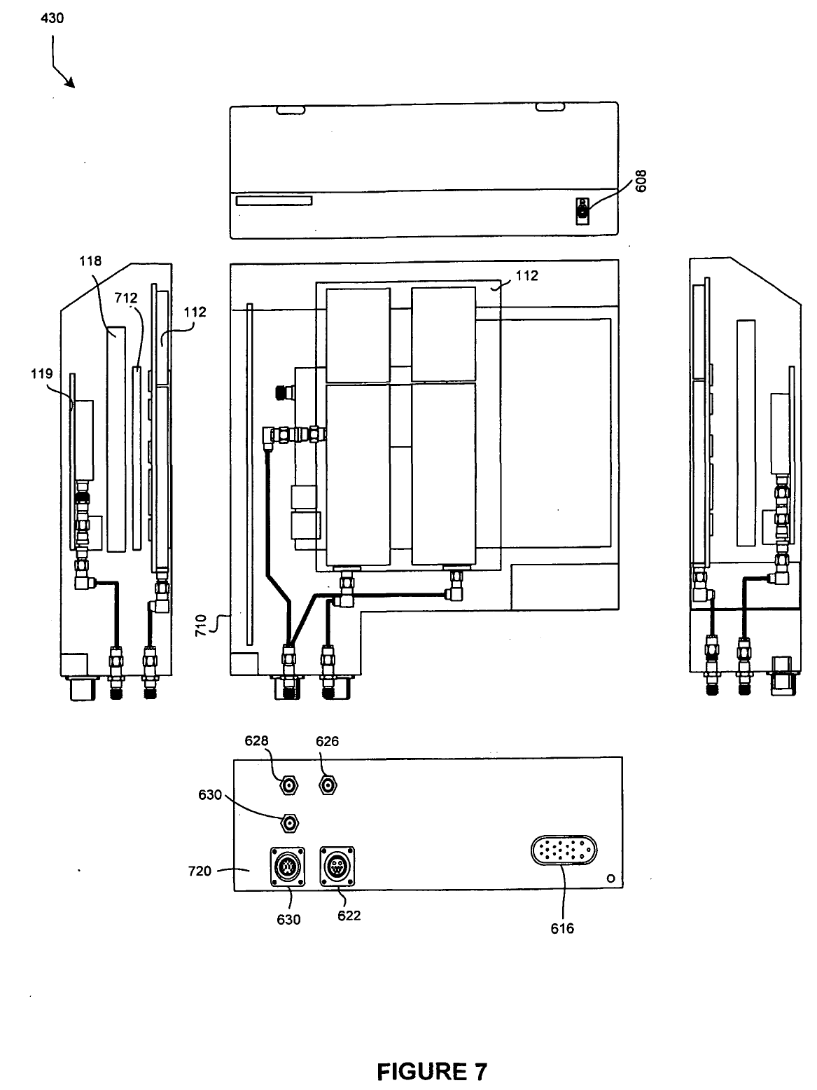

The MMST 110 is an ultra-compact package that fits within the space of a dual SINGARS radio system. The design maximizes commercial-off-the-shelf components applied for use in a tactical mobile environment. Size reduction is achieved by eliminating the housing and power supplies from each of the items and mechanically mounting the functional circuit cards from each of the units into a common chassis driven by a common power supply as shown in greater detail in reference to FIGS. 5 and 7. Circuit cards for individual elements are attached to the chassis housing through a series of stacked plates and stand-offs to provide mechanical stability needed to survive vibration and shock of portable environment. Heat sinks 450 on both the SATCOM unit 410 and the integrated radio unit 420 assist in the dissipation of heat of the compact satellite terminal 110.

A main power cable supplies DC power from the vehicle 104 to the SINCGARS tray 200. The system 150 gets its primary dc power through a power cord 460 and the blind mate connector 462 in the SINCGARS tray. The power schematic is shown in reference to FIG. 9.

Turning now to FIGS. 5A and 5B, illustrated are front and back perspective assembly view of the SATCOM unit 410. The SATCOM unit 410 is designed to be antenna agnostic while occupying no more space than a vehicle multiband UHF/VHF radio 420. Electronics are located in sealed environment to protect them from driven rain and dust.

Heat dissipation is a major hurdle in designing compact electronic equipment. The top cover 502 is a heat dissipating shield. In addition, the internal boards have thermal plates and internal heat sinks 532 to distribute heat away from hot spots. This approach allows electronics to be maintained in a sealed environment while extending the operating temperature range.

Using conductive cooling, heat is transferred from the mobile interface cards (MICs) to the exterior of the enclosure. The metal enclosure itself forms a large heat sink. As a result, internal fans are not required. The left side panel 504, the right side panel 528, and the bottom cover 524 enclose the unit 410 and provide structure to house the internal components. The front panel 514 has LED displays, a liquid crystal display 512, an audio jack 520, and Ethernet connections 516 and USB connections 518. The rear panel 530 supports additional Ethernet 516, serial 534 and USB connectors 518.

A high speed mobile access router card (HMARC) 114, such as HMARC 3720 from CISCO, creates an IP network for a vehicle 104, enabling secure voice, video, and data communications with a network operations center or any user connected to the IP network. The vehicle network maintains transparent connectivity whether the vehicle is stationary or in motion. The router card 114 includes host processor, memory, ports, and LED signals. With onboard hardware encryption, the HMARC 114 provides highly secure yet scalable video, voice, and data services for mobile networks. To ensure transparent connectivity to the roaming vehicle network, the HMARC 114 has integrated standards-based Mobile IP software into the IOS software. Mobile IP allows transparent roaming over multiple wireless networks. For example, cellular, satellite, or 802.11 wireless modems can be connected to the HMARC 114 providing multiple wireless network connections to the vehicle network. A PCI bus connector supports communication between a Fast Ethernet switch mobile interface card (FESMIC) 508 and the router card 114. The Fast Ethernet switch mobile interface card 508, such as 3201 FESMIC from CISCO, provides the router with 4 high-speed sets of switched Fast Ethernet signals. The FESMIC 508 provides autosensing of switched Fast Ethernet interfaces, auto-MDIX (medium-dependent interface crossover), support for 802.1 D standard bridging, 802.1Q trunking, 802.1P class of service (CoS), and Layer 3 routing support between VLANs. An interconnect 522 provides a physical port to easily connect circuit card assemblies. A mobile router power card, such as C-3201 MRPC from CISCO, distributes power to components as needed. A single board computer (SBC) 526, such as COBRA EBX-120, provides the SATCOM unit 410 with programmable processing power.

As described, the router card 114 and Ethernet switch 508 is accomplished by using a multi-board version of the CISCO 3270 MOBILE ACCESS ROUTER. One board is the main router 114, another is the FESMIC fast Ethernet switch 508, and the third is a mobile router power card 510. All three boards and the SBC 526 are stacked together (PC-104 architecture) and mounted in the upper assembly of the IF Subsystem.

As shown, circuit cards for individual elements are attached to the chassis housing through a series of stacked plates and stand-offs to provide mechanical stability needed to survive vibration and shock of portable environment.

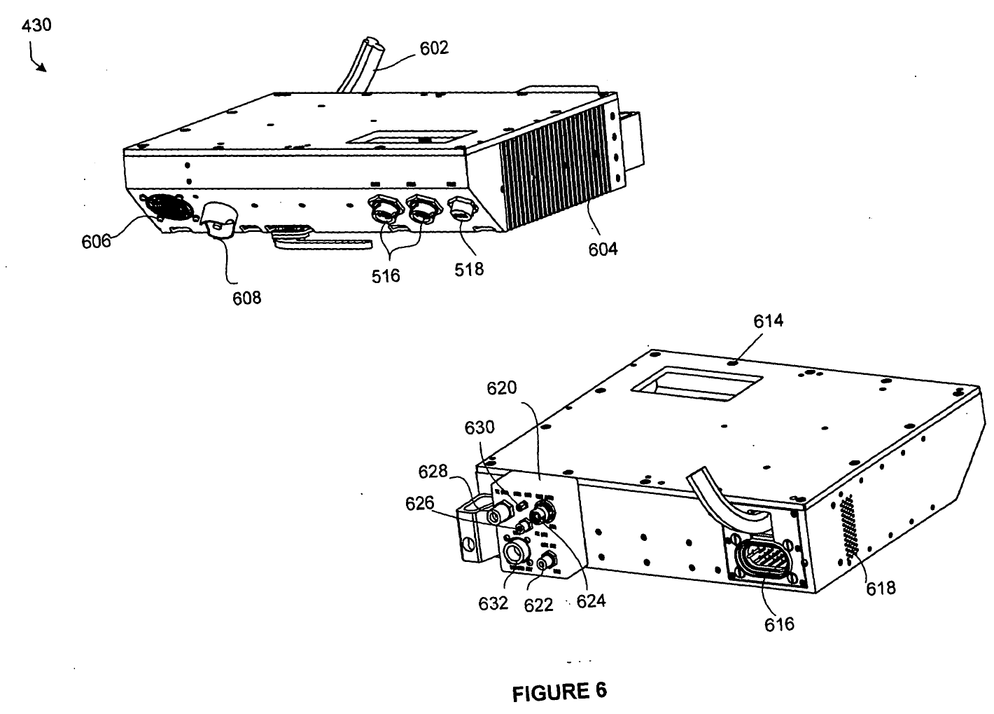

Turning now to FIG. 6, illustrated are front and back perspective view of the bottom unit 430 of the MMST 110. As shown in FIG. 4, the bottom unit 430 installs into existing SINCGARS mount 200. Screw holes 614 enable the upper units 410, 420 to be physically attached to the lower unit 430. Main power cable 602 supplies the DC power to the lower unit 430. Connector 616 supplies power to the antenna system 130. A main switch 608 enables the unit 430 to be shut down or turn on.

Unique thermal design is used to allow commercial grade components to be used in harsh tactical mobile environment. Power supply heat sinks are located in a chamber that opens to the external environment and are isolated from the electronics. A fan is used to flow air from an air supply perforation 518 through this chamber to take the primary source of heat away from the internal electronics and out through the fan vent 6. The lid of the upper chassis and side of the lower chassis also includes heat sink fins 604 to provide more surface area for heat to be carried away from the internal components. Also previously shown, using internal heat sinks and thermal pads on the circuit boards distribute heat away from hot spots. This comprehensive approach allows electronics to be maintained in a sealed environment while extending the operating temperature range.

The external real panel has a connector box 620 to interconnect communications with the upper units 410, 420. The connector box 620 includes a satellite transmit 628 and receive cable assembly 626, an LMR audio cable assembly 624, modem control cable assembly 630, OTM antenna cable assembly 622, and a BUC/OTH cable assembly 632. The external front panel also includes Ethernet connections 516 and a USB connection 518 for external communication interfaces.

Connection from the satellite subsystem 130 to the IF Subsystem 110 consists of two coaxial connections for transmit and receive data through 50Ω coax. One cable runs from the modem transmit 628 to the BUC 124, and the other from the modem receive port 626 to the LNB 126. Both cables provide DC power and 10 MHz reference, as well as the signals. A third cable is an RS-232 serial port connection to the antenna base for controlling the positioner and providing power to the base. A fourth cable is a serial control cable to the BUC 124 for management and control.

Turning now to FIG. 7, illustrated is an internal view of the bottom unit 430. The lower casing 710 houses the antenna control unit (ACU) 119, radio over IP unit 118, power supply module 712, and the satellite board modem 112. The MMST 110 is constructed to be antenna 120 and modem 112 agnostic. The unit 430 is assembled in a cassette type arrangement so that modular cards can be easily replaced or substituted.

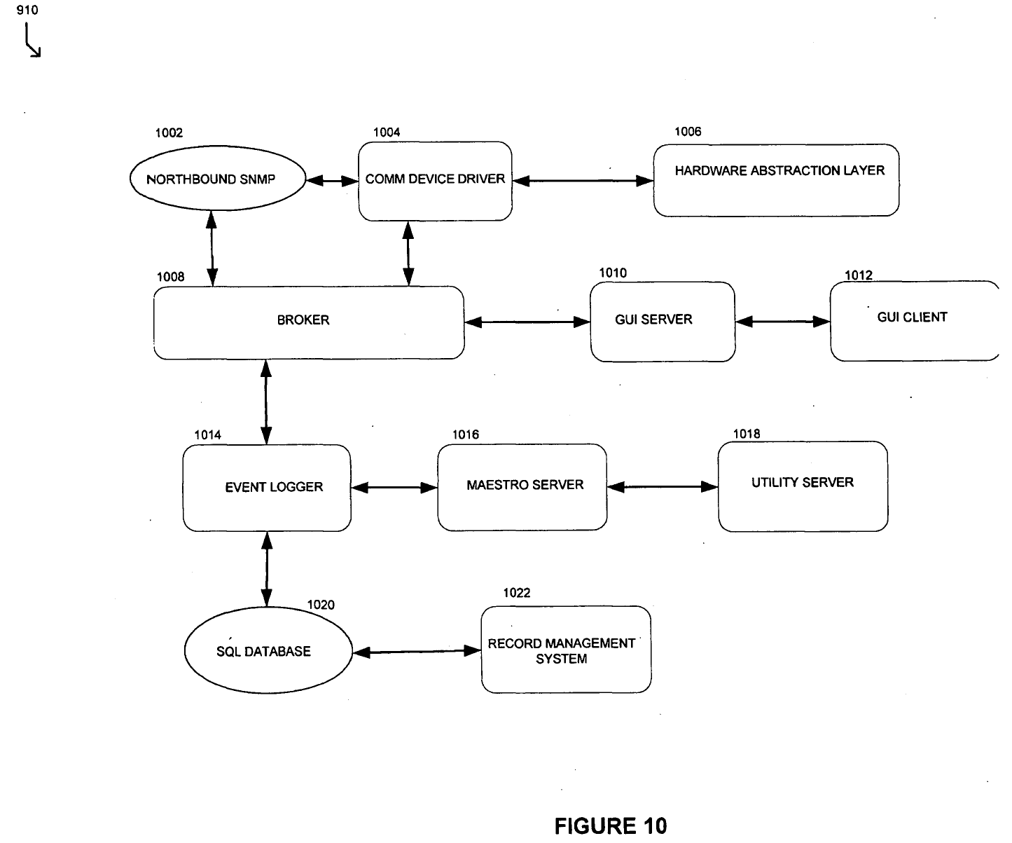

The modem circuit board 112 is installed inside the MMST chassis. Within the MMST chassis, a standard Ethernet interface is used between the modem 112 and baseband system. A standard L-band interface is used between the modem 112 and the antenna group 130. This configuration allows any modem that uses an Ethernet data interface and L-Band IF interface to be used. The system also includes multiple DC power supplies that support a variety of modems that may require different DC voltages, e.g., 12V, 24V and 48V. The MMST chassis also includes an embedded network and element management system as described in reference to FIG. 10. The management and control system 116 is highly configurable through installation of modem specific driver software. This configuration allows a common modem control interface that can be used with any modem. The embedded single board computer 526 includes both serial and Ethernet interfaces to support modem control interfaces of either type.

In the preferred embodiment, the satellite board modem 112 is based on a two printed circuit card design. The standard configuration consists of an L-Band assembly and a digital baseband assembly. The L-Band/IF printed circuit card consists of an analog modulation function, an analog complex down conversion, and two wide-band digital synthesizers. In the modulator, analog in-phase (I) and quadrature (Q) signals are generated on the digital baseband printed circuit card, routed to the L-Band printed circuit card, and modulated at the desired frequency. The L-Band modulated signal is then passed through a microprocessor controlled variable attenuator providing gain control of the output signal. In the complex down converter, the signal for demodulation is amplified and sent through a variable wideband attenuator for automatic gain control (AGC). The gain-controlled signal is then passed through a complex down converter to a low IF. Digital baseband processing printed circuit card provides a flexible architecture that allows many different modes of terrestrial and satellite framing, digital voice processing, and differing modulation/demodulation formats. The coaxial transmit 628 and coaxial receive connection 626 enable data communications with the satellite modem 112. A monitor and control interface 630 enables monitor and control functionality of the modem 112.

The antenna 120 includes an LNB 126 for converting the received Ku RF and providing L-band to the subsystem 110. On the transmit side, the antenna subsystem 130 employs a BUC/PA 124 for converting the L-band IF to Ku band. The Antenna Control Unit (ACU) 119 is responsible for positioning the antenna 120 to the desired satellite 102, and maintaining the position during operation, and the ACU 120 is controlled by the Monitor and Control (M&C) software.

The antenna control unit 119 serves to orient the antenna system 130 toward a satellite 102 in real time. In the preferred arrangement, a Global Positioning System (GPS) transmits position information received from the satellite 102 to the ACU 119. Then, the ACU 119 checks a position of the antenna 120 and a relative direction of the satellite 102 by using sensed position information, and controls the antenna rotating motors. A software device driver will monitor and control the controller settings. The ACU 119 interfaces through two serial ports; one connected to the M&C system, and the other connected to the modem for satellite positioning feedback. Some antenna do not require a separate ACU 119. In this case, it is connected to the M&C system through a serial cable. Both DC power and bi-directional control and status information is connected to the antenna through a single coaxial cable. An OTM cable assembly 622 and OTH cable assembly 632 enable the ACU 119 to interface with satellite antenna 120.

A radio over Internet Protocol RoIP system 118 captures analog audio used by land mobile radio systems 108 and converts that audio to digital datagram, which in turn, can be transported over a digital network. Preferably, this module 118 is the JPS RAYTHEON NXU-2A. It 118 interfaces with the land-mobile radio 108 through an analog speaker, microphone, and PTT interface. On the digital side, it interconnects through an Ethernet port. This board 118 will be mounted in the lower assembly 430 of the IF Subsystem 110. The system 150 addresses the essential control signals used by land mobile radios 108. These control signals consist of the carrier operated relay (COR) signal generated by a device when it is receiving a radio transmission and the push to talk (PTT) signal which requests a device to begin a radio transmission.

For maintenance, the modular cards may be replaced while the system is in the vehicle. The modem or ACU card is accessed by removing screws in the front panel and pulling the tray out. The internal connections are made via blind mate connections. The replacement board is inserted likewise. Upon full insertion of the tray and installing the screws, the front panel retains its original seal capability to protect against dust and liquids.

The power supply module 712 distributes DC power throughout the MMST system 150. Power cable assembly interconnects the power connector assemblies 712. FIG. 8 shows a power distribution schematic in detail.

Turning now to FIG. 8, the MMST 110 gets its primary power through a blind mate connector in the SINCGARS tray. Power supply modules 712 receive power from the vehicle 104 and distribute the power through out the system 150. The power supply supports a broad range of input DC voltage. This range of voltage support is to accommodate both military (28V) and commercial (12V) vehicles 104.

A power plug 810 from the vehicle connects the system 150 to 28V DC power. The J1 connector 804 provides the vehicle supplied DC power to the power board assembly 712. The power board assembly 712 steps down the voltage to provide lower voltage to various components as needed. The board assembly 712 connects to power connector J2 802 which supplies power to a second power board assembly, connector J3 806 which supplies low voltage power to the single board computer 526 and to the router 114 in the SATCOM unit 410, connector J4 808 which supplies power to the modem 112, ACU 119, and mobile radio interface 118 in the lower unit, and connector J5 616 which supplies power to the antenna system 130.

Turning now to FIG. 9, the Software Subsystem 900 provides necessary hardware interaction for an end-user to quickly and easily deploy and establish satellite and/or radio communications. The embedded software 900 of the MMST 110 provides the monitor and control 116 of the hardware necessary to establish COTQH 304 and COTM 302 functionality. Network management control software 910, such as MAXVIEW by DATAPATH, INC., is the core software application of the MMST 110. Core functionality encompasses all of the reaction to external and internal stimulus detected by the software such as control of startup, pre-configuration, configuration change, pushbutton initiate communications, end communications, determine severity of alarms, determine appropriate response to alarms, provide troubleshooting guidance, and interface to web browser.

Network management is the core functionality of the embedded network management control suite 910. No core software changes are required for deployment of new or additional hardware. The network management control system 910 is highly configurable through installation of device specific driver software. The drivers interpret responses from GUI screen on web browser and front panel inputs as related to the device function and provides appropriate controls to device.

The MMST software suite 910 permits the user full control over the hardware via a remote operational mode or via local control. The remote control is accomplished via an external network management system (ENMS) 950 or a telnet console 960, and local control via a front panel unit 930 or a serial console 940. These interfaces provide flexibility of management depending on the situation. With the exception of the front panel interface 930, the other interfaces interact with the system 900 via an external computer 144, such as a laptop. The MMST software system 900 is hosted on a single board computer (SBC) 526 running a Linux OS. The network management control software 910 provides a customizable graphical interface to the system hardware 920. An FTP server installed on the OS provides the user ability to push and pull files from the SBC 526. Additionally, in HTTP web server is installed and provides the user access to a record management system.

Through the user of a connected laptop 144, the software supports a command line interface that allows for control of the system 900 from a serial console 940. For local control of the MMST 1100, the operator has the ability to change settings via a LCD panel control 930 on the front panel display. The embedded software hardware interface 920 supports multiple equipment manufacturers for multiples types of hardware equipment without changes to core software code. A software driver is loaded into the system to support new or additional equipment.

The network management control system 910 is highly configurable through installation of modem specific driver software. This allows a common modem control interface that can be used with any modem. The embedded single board computer 526 includes both serial and Ethernet interfaces to support modem control interfaces of either type.

The system 900 uses several techniques that result in a baseband agnostic capability. The system includes an embedded router 114 and switch 508 for interconnection to any IP network baseband equipment. The network management control system 910 is also able to interface with and control any set of baseband equipment. The IP based baseband enables interfacing to a wide variety of fielded equipment. The IP based baseband includes enables interfacing with external routers or external modems driven by the internal router and VoIP functions.

Upgrades may take place via an external laptop 114 through the M&C software or using a USB drive with the upgrade software. When the SBC 526 identifies a drive attached to the USB, the upgrade option is available on the front panel menu.

Configuration is performed using the separate laptop 114 or in the internal computer 526. If the Monitor and Control (M&C) software is on the single board computer 526, then the user will use a browser window to access it. The M&C screens are used to set configuration options of the modem 112, ACU 119, Front panel, RoIP 118, and router 114.

Turning now to FIG. 10, the architecture of the network management suite 910 is illustrated. The NMS modules run as services on the MMST SBC 526. The ENMS 950 provides a secure GUI client 1012 that runs on an external laptop 144 and connects to the GUI server 1010 running on the MMST SBC 526 via an Ethernet connection. GUI Server 1010 handles all message traffic between the GUI 1012 and the Broker 1008. The NMS 910 interfaces with the following system devices:
OTH Antenna Controller via serial RS232 interface.
OTM Antenna Controller via serial RS232 interface.
Ethernet switch via SNMP interface.
JPS NXU2 via serial RS232 interface.
Radio to SIP via serial RS232 interface.
Satellite modem via serial RS232 interface.
BUC via serial RS232 interface.
HPA via serial RS232 interface.
   Hardware control 1006 is accomplished by creating communication device driver (Comm) and broker device drivers. Comm 1004 communicates with each of the devices using the vendor specified communications protocol. The data retrieved from each device is then reported to broker 1008 where the broker device driver parses and manipulates the data to provide usable information to the GUT client 1012.

Based on the number of serial devices in the system, an external terminal server can be used for some of the devices. The Broker 1008 parses and interprets the device specific data acquired by Comm 1004. The Broker 1008 also packages user commands from the GUT client 1012 and presents the information to Comm 1004 for execution. Broker 1008 provides a northbound SNMP engine 1002 for interfacing with external interfaces.

As a part of the embedded operation of the system, the operator connects to the MMST system 900 through the use of a standard web browser. The web interface 940 will have the same general look and feel as the GUI client 950 but will not require the use of any additionally installed software.

Utility Server 1018 negotiates all user login and also handles connection requests to the all other modules. The user will be prompted with a login prompt where he/she provides a username and password. Once the user has completed the login process, he/she will be able to view a set of customized panels designed for monitoring and controlling the MMST system devices. The layout presents the panels from a top level system view to detailed device type panels, creating a logical and intuitive graphical system view.

The client 1012 also provides graphical panels that allow the user to manually configure all MMST system device settings, disable/enable all external control interfaces, initiate and complete all autonomous tasks such as the ability to load and execute preset configurations, and accomplish signal acquisition.

The MMST 110 provides the user control via a front panel LCD unit 930. A Linux LCD driver provides a bridge between the unit and the NMS 910. Keypad interaction passes through to a Comm LCD device driver. The Comm device driver provides a state machine, which based on the last state and the key pressed, determines the current state. The Comm driver produces this state/menu item on the LCD, thereby accomplishing an advanced menu structure. The menu system allows the user to control features of each device that are needed to achieve uplink/downlink. The comm device driver allows the NMS 910 a point of interaction with the Linux LCD driver. The comm driver provides the NMS 910 the ability to:

Polls for keyboard interaction, set LED state

Query for user interaction with keypad (which keys have been pressed)

Set LED state On/Off

Set LCD Text

Clear LCD Text

The Comm 1004 reports to a Broker 1108 the current state/menu item selected and the key pressed. If the key pressed is the “select” key, a flag will toggle high. An event driven automation engine 1016 will then trigger the appropriate macro to accomplish the desired task based on the state/menu selection.

Comm device communications server repeatedly polls SNMP 1002, serial and discrete devices for status. Information from the data is propagated to the GUI client 1012 providing real time reporting of all device status. EventLogger 1014 captures and records device status in a SQL data storage container 1020.

Maestro Server 1016 is an event driven automation engine is used extensively to perform all autonomous tasks as well as bridging external control interfaces to the NMS 910. Maestro controls the LED states. Any hardware faults or failure triggers the RED LED to the On state. If a set of conditions (TBD) indicate a loss of signal or a compromised signal Maestro 1016 triggers the AMBER LED to the On state. When Maestro is running a super macro the GREEN LED is set to a flashing state indicating that the system is busy. When Maestro 1016 has completed all tasks the GREEN LED returns to a steady state. Maestro 1016 interacts with the LEDs via the Comm 10014 and Broker LCD device drivers.

A records management system 1022 provides the user access to view recorded system events as well as all recorded device status.

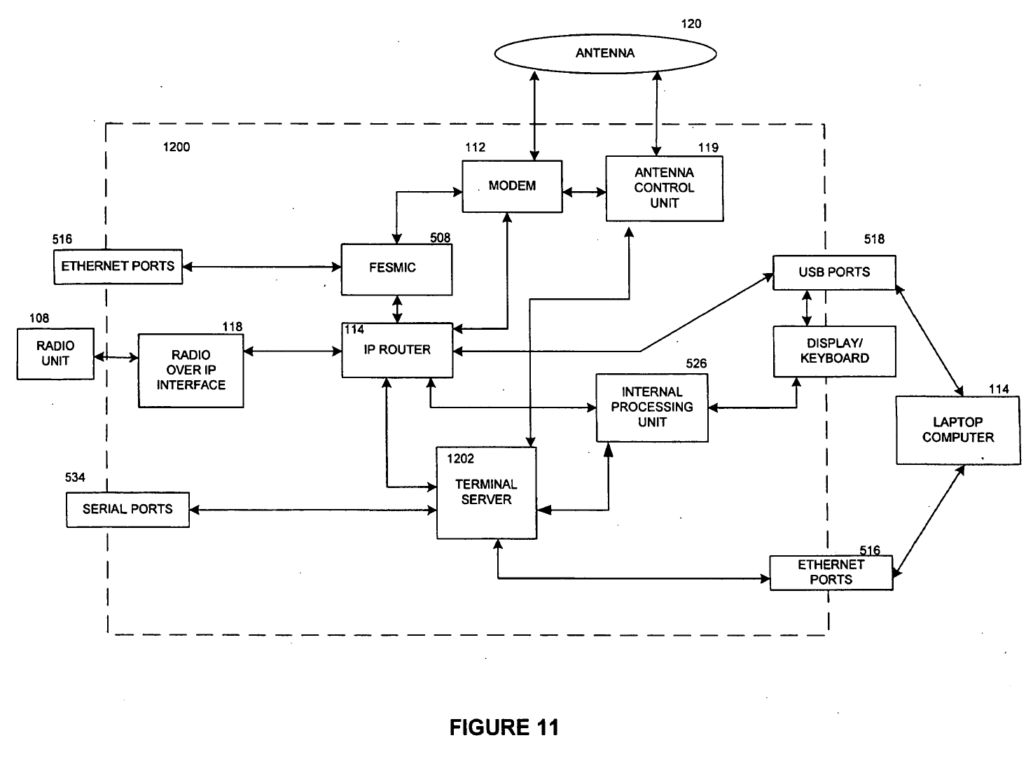

Turning now to FIG. 11, illustrated is interconnect diagram of the MMST system 150. The system 150 uses everything over IP architecture 1200. The system 150 possesses antenna, modem and baseband agnostic functions. A terminal server 1202 aggregates multiple communication channels.

The system 150 includes tactical radio system 420 that supports communications to a network of mobile end users. The mobile end user device 108 can be a handheld unit or vehicle based radio unit. The integrated tactical radio 420 can communicate to other tactical radio users while mobile.

The system 150 includes a satellite modem 112 connected to a SATCOM-on-the move antenna system 302 allowing the terminal 110 to communicate over the satellite link while moving. The satellite modem 112 passes IP traffic to the integral router 114 over an Ethernet interface.

The system 150 includes an integrated router 114 which is configured with VLAN tunnels to routers located in other fixed and mobile terminals to maintain communications while terminals are mobile. The integral router 114 interconnects the satellite network and the tactical radio network.

The system 150 includes an integrated Radio over IP module 118 that converts the standard analog audio push-to-talk interface from the tactical radio 420 to IP and supports bi-directional traffic. When interconnected via the IP network 1200, the distant end system can use a software client or separate Radio over IP module to present the PTT and audio to the user. PTT audio interface from the integrated tactical radio unit 420 is passed to the radio over IP module 118 to make it assessable to any end device connected to the IP network 1200.

The integrated tactical radio 420 includes a serial interface 534 as a second communications interface available to the mobile users. The integrated single board computer 526 includes client software that can convert the serial traffic to IP which is then passed over an Ethernet interface to the integrated router 114. An integrated satellite modem 410 includes an IP interface to the integrated router 114. Connection to the SATCOM on-the-move antenna system 302 enables mobile IP traffic, which is then passed to the SATCOM modem 112, allowing simultaneous mobile tactical radio users to communicate with the hub while simultaneously passing video and data over the same IP network 1200.

The system 150 uses several techniques that result in an antenna 120 agnostic capability. This agnostic capability allows both on-the-move 302 and on-the-halt antenna system 304 solutions to be provided. The system 150 uses a standard L-Band interface between the MMST chassis 110 and the antenna group 130. By using an integrated L-Band block upconverter 124 and LNB 126 as part of the antenna group 130, any antenna system 130 can be used. Antenna agnostic capability is also enabled by integrating a modular antenna controller unit 119, specific to the antenna 120, into the MMST chassis 110. Simply plugging in the antenna control unit 119 into the mobile link chassis 110 allows any antenna system 130 to be used. For those antenna systems 130 with the ACU integrated into the antenna pedestal, the MMST system 150 includes both serial 524 and Ethernet interfaces 516 for control of the antenna system. The MMST chassis 110 also includes an embedded network and element management system 910. The network and element management system 910 is highly configurable through installation of antenna specific driver software. This allows a common antenna control interface that can be used with any antenna system 130. The system 150 also includes multiple DC power supplies 712 that support a variety of antenna systems 130 that may require different dc voltages, e.g., 24V and 48V.

The system uses several techniques that result in a modem agnostic capability. The modem circuit board is installed inside the MMST chassis 110. Within the MMST chassis 110, a standard Ethernet interface is used between the modem and baseband system. A standard L-band interface is used between the modem 112 and the antenna group 130. This configuration allows any modem that uses an Ethernet data interface and L-Band IF interface to be used. The system also includes multiple DC power supplies that support a variety of modems that may require different de voltages, e.g., 12, 24V and 48V. The mobile link chassis 110 also includes the embedded network and element management system 910. The embedded network management system is highly configurable through installation of modem specific driver software. This allows a common modem control interface that can be used with any modem. The embedded single board computer 526 includes both serial and Ethernet interfaces to support modem control interfaces of either type.

The system uses several techniques that result in a baseband agnostic capability. The system includes an embedded router 114 and switch 508 for interconnection to any IP network 1200 baseband equipment. The embedded software system 900 is also able to interface with and control any set of baseband equipment. The IP based baseband allows for ready interfacing to a wide variety of fielded equipment 142.

The system uses several techniques that result in a radio agnostic capability. The system uses a radio-over-IP converter 118 allows voice traffic conversion to the mobile link IP network 1200 for any radio that incorporates a standard analog audio push-to-talk interface.

In view of the foregoing detailed description of preferred embodiments of the present invention, it readily will be understood by those persons skilled in the art that the present invention is susceptible to broad utility and application. While various aspects have been described in the context of a preferred embodiment, additional aspects, features, and methodologies of the present invention will be readily discernable therefrom. Many embodiments and adaptations of the present invention other than those herein described, as well as many variations, modifications, and equivalent arrangements and methodologies, will be apparent from or reasonably suggested by the present invention and the foregoing description thereof, without departing from the substance or scope of the present invention. Furthermore, any sequence(s) and/or temporal order of steps of various processes described and claimed herein are those considered to be the best mode contemplated for carrying out the present invention. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the present inventions. In addition, some steps may be carried out simultaneously.

Accordingly, while the present invention has been described herein in detail in relation to preferred embodiments, it is to be understood that this disclosure is only illustrative and exemplary of the present invention and is made merely for purposes of providing a full and enabling disclosure of the invention. The foregoing disclosure is not intended nor is to be construed to limit the present invention or otherwise to exclude any such other embodiments, adaptations, variations, modifications and equivalent arrangements, the present invention being limited only by the claims appended hereto and the equivalents thereof.

The invention claimed:

1. A mobile communication system, comprising:
a multiband mobile terminal having electrically interconnected slots to receive functional modules operable to provide uninterrupted cross-banding between radio and satellite communication, wherein the functional modules include:
a satellite modem with an L-band interface for communications with an antenna system;
an antenna control unit functional to interface with the antenna system;
a radio over IP unit coupled to a radio system functional to transmit and receive analog radio signals;
a computer board system configurable to control the satellite modem, the antenna control unit, and the radio over IP unit by device drivers over a baseband network; and
a router operable to interconnect the functional modules forming the baseband network; and
a power system operable to supply a range of voltages to the functional modules

2. The system of claim 1, wherein the multiband mobile terminal is mechanically and electrically operable to interface directly to a standard military single channel ground and airborne radio system (SINCGARS) mounting tray.

3. The system of claim 1, wherein the multiband mobile terminal has a length that is shorter than 15 inches and the width is shorter than 16 inches.

4. The system of claim 1, wherein the antenna system includes a flat antenna operable for cross-banded communications while moving.

5. The system of claim 1, wherein the multiband mobile terminal system is operable to interface with either a flat antenna operable for on the move satellite communications or an extendable antenna operable for on the halt satellite communications.

6. The system of claim 1, wherein the electrically connected slots have connectors operable to enable the satellite modem to be changed out to support different satellite antennae by the removal and insertion of different satellite board modems.

7. The system of claim 1, wherein the functional modules are attached to a chassis housing through a series of stacked plates with stand-offs to provide mechanical stability operable to survive vibration and shock of a moving vehicle.

8. The system of claim 1, further comprising an upper and lower chassis, wherein a lid of the upper chassis and a side of the lower chassis include heat sink fins operable to provide greater surface area for heat to be carried away from internal components

9. The system of claim 9, further comprising internal heat sinks and thermal pads on the functional modules to distribute heat away from hot spots.
